(19) United States
(12) Patent Application Publication
(10) Pub. No.: US 2013/0314318 A1
(43) Pub. Date: Nov. 28, 2013

(54) METHOD OF IMPROVING CURSOR OPERATION OF HANDHELD POINTER DEVICE IN A DISPLAY AND HANDHELD POINTER DEVICE WITH IMPROVED CURSOR OPERATION

(71) Applicants: Ching-Hung Tseng, Hsinchu (TW); Hsin-Po Wang, Hsinchu (TW)

(72) Inventors: Ching-Hung Tseng, Hsinchu (TW); Hsin-Po Wang, Hsinchu (TW)

(21) Appl. No.: 13/481,793

(22) Filed: May 26, 2012

(51) Int. Cl. G06F 3/033

(52) U.S. Cl. 345/158

(57) ABSTRACT

A method and apparatus of improving cursor operation of handheld pointer device in a display is provided, applicable to a handheld pointer device and a display. The display can display a cursor indicating the location of a handheld pointer device in a display. The method includes the steps of: the handheld pointer device transmitting a control signal to the display to enter a slow cursor movement mode; the display in the slow movement mode receiving a control signals transmitted by the handheld pointer device; the display showing a slow moving cursor accordingly when the control signal being a move cursor command; the display exiting the slow cursor mode and entering selected object when the control signal being a select object command; and the display exiting the slow cursor movement mode when the control signal being an exit mode command.

### FIELD OF THE INVENTION

The present invention generally relates to a method of improving cursor operation in a display, and more specifically to a method of improving cursor operation of a handheld pointer device in a display for easily selecting a target object in the display, and a handheld pointer device for performing improved cursor operations.

### BACKGROUND OF THE INVENTION

The various internet TV programs or interactive game stations developed recently usually use a display to show a view of operation screen and a handheld pointer device, such as, a light gun or an air mouse, for remote operation and control. The handheld pointer device is used to select the target object in the operation view and select the functions associated with the target object. The target object can be an icon or a visual object displayed in the operation screen.

This type of handheld pointer device is handheld and operated in the air without placing on any auxiliary surfaces, such as, a desk surface. The operation is also from a distance of a few meters. Hence, the operation usually suffers trembling from user hand or caused by button pressing on the handheld pointer device. These trembling usually will affect the accurate pointing to the target object in the display, especially for smaller-size objects, and thus resulting in selecting the wrong object or taking longer time to select an object. This deficiency severely impedes the popularity and effectiveness of such applications. It is imperative devise a solution to overcome the above-mentioned deficiency.

### SUMMARY OF THE INVENTION

The primary object of the present invention is to provide a method and device of improving cursor operation of handheld device in a display, by solving the trembling of the handheld pointer device caused by hand shaking for button pressing, resulting in degradation of accurate target selection.

An exemplary embodiment of the present invention provides a method of improving cursor operation of handheld device in a display, applicable to a handheld pointer device and a display. The display displays a cursor to represent the corresponding location and movement of the handheld pointer device. The handheld pointer device can transmit a plurality of control signals to the display to perform a corresponding function. For example, in an embodiment, the control signals may include an enter mode command, a move cursor command, an select object command and an exit mode command, each corresponding to entering a specific operation mode, moving a cursor displayed on the display, selecting an object display on the display, and exiting a specific operation mode respectively. In this embodiment, the specific operation mode is a slow cursor movement mode. By slowing the movement of the cursor on the display so that the cursor displayed on the display can be easily controlled and moved to select a target object displayed on the display. The method includes the following steps: the handheld pointer device transmitting a control signal to the display to enter a slow cursor movement mode; the display in the slow movement mode receiving a control signal transmitted by the handheld pointer device; the display showing a slow moving cursor accordingly when the control signal being a move cursor command; the display exiting the slow cursor mode and entering selected object when the control signal being a select object command; and the display exiting the slow cursor movement mode when the control signal being an exit mode command.

Another exemplary embodiment of the present invention is to provide a handheld pointer with improved cursor operation, applicable to a display. The display displays a cursor to represent the corresponding location and movement of the handheld pointer device. The handheld pointer device can transmit a plurality of control signals to the display to perform a corresponding function. For example, in an embodiment, the control signals may include an enter mode command, a move cursor command, an select object command and an exit mode command, each corresponding to entering a specific operation mode, moving a cursor displayed on the display, selecting an object display on the display, and exiting a specific operation mode respectively. In this embodiment, the specific operation mode is a slow cursor movement mode. By slowing the movement of the cursor on the display so that the cursor displayed on the display can be easily controlled and moved to select a target object displayed on the display. The handheld pointer device includes a slow-move button. When the slow-move button is pressed, a control signal is transmitted to the display so that the display enters a slow cursor movement mode. Any subsequent cursor movement operation in the slow cursor movement mode will slow mode to improve the operation. When the display is already in a slow cursor movement mode and the slow-move button is pressed again, the display will exit the slow cursor movement mode and restores normal cursor movement speed.

According to an embodiment of the present invention, the handheld pointer device of the present invention is a light gun.

According to another embodiment of the present invention, the handheld pointer device of the present invention is an air mouse with a touch pad for cursor movement control.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of the operation of the present invention in an applicable system according to the invention;

FIG. 2 shows a flowchart of an embodiment of a method of improving cursor operation in a display according to the invention;

FIG. 3 shows a schematic view of a first embodiment of a handheld pointer apparatus with improved cursor operation according to the present invention; and

FIG. 4 shows a schematic view of a second embodiment of a handheld pointer apparatus with improved cursor operation according to the present invention.

### DETAILED DESCRIPTION OF THE PREFERRED EMBODIMENTS

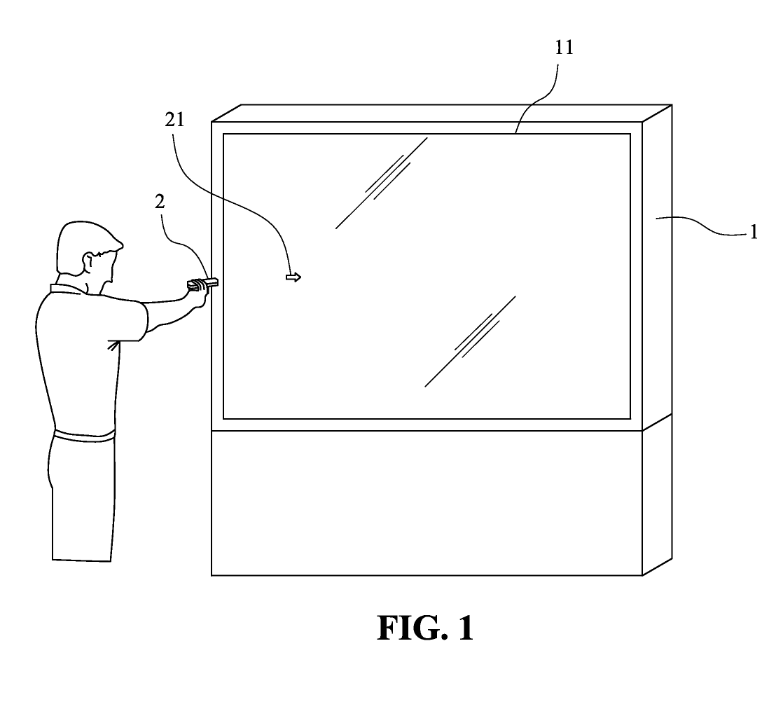

FIG. 1 shows a schematic view of the operation of the present invention in an applicable system according to the invention. The system includes a display 1 and a handheld pointer device 2. Display 1 can be connected through either built-in or externally added connection to sensor unit, computer host, related control unit, and so on, for receiving the signals or commands issued by handheld pointer device 2. Display 1 displays a related operation screen 11 and a cursor 21 indicating the location of handheld pointer device 2. Cursor 21 is to select a target object displayed in operation screen 11 and the operation function associated with the selected target object. Display 1 may be a TV, computer monitor or projection screen for projector.

Handheld pointer device 2 does not need to be placed on any surface operate. Instead, handheld pointer device 2 is to be held in the air for operation, such as, a light gun. The method of the present invention is to improve the problem that the operation usually suffers trembling from user hand or caused by button pressing on the handheld pointer device. These trembling usually will affect the accurate pointing to the target object in the display, especially for smaller-size objects, and thus resulting in selecting the wrong object or taking longer time to select an object.

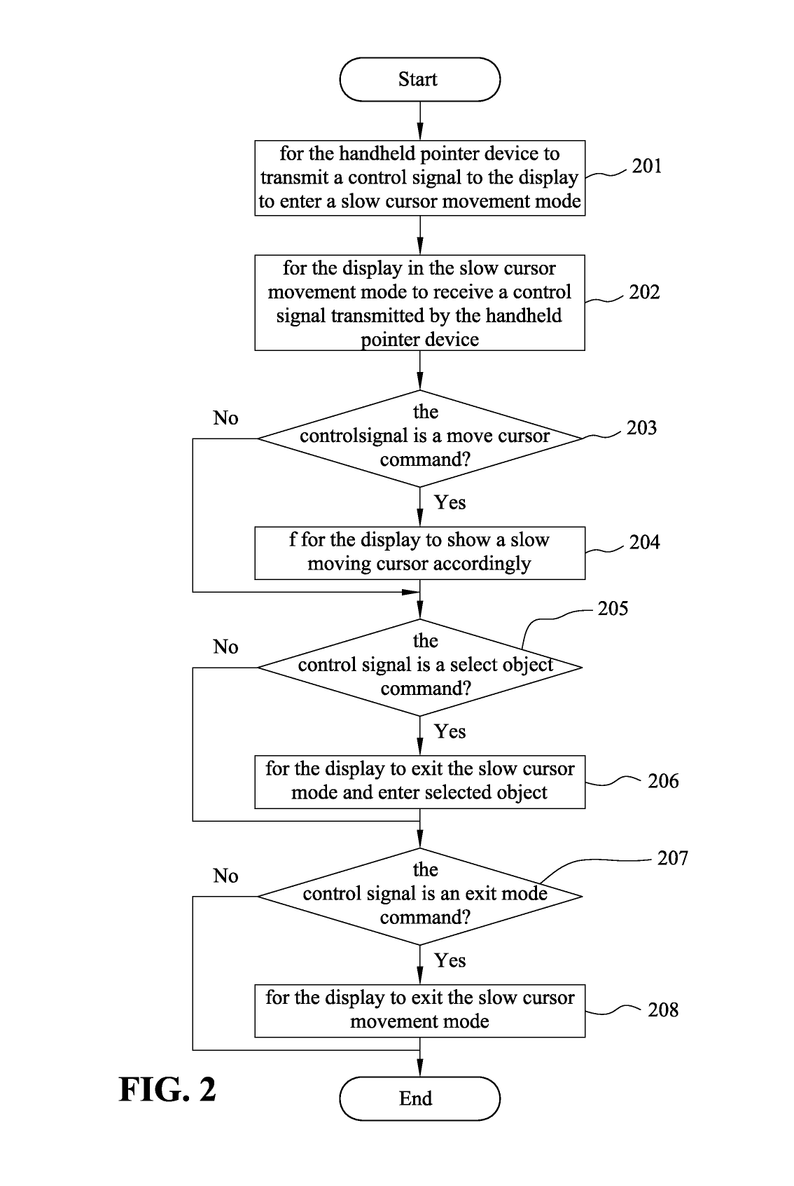

FIG. 2 shows a flowchart of an embodiment of a method of improving cursor operation in a display according to the invention, applicable to a handheld pointer device and a display. The display displays a cursor to represent the corresponding location and movement of the handheld pointer device. The handheld pointer device can transmit a plurality of control signals to the display to perform a corresponding function. For example, in an embodiment, the control signals may include an enter mode command, a move cursor command, an select object command and an exit mode command, each corresponding to entering a specific operation mode, moving a cursor displayed on the display, selecting an object display on the display, and exiting a specific operation mode respectively. In this embodiment, the specific operation mode is a slow cursor movement mode. By slowing the movement of the cursor on the display so that the cursor displayed on the display can be easily controlled and moved to select a target object displayed on the display.

As shown in FIG. 2, the method includes the following steps. Step 201 is for the handheld pointer device to transmit a control signal to the display to enter a slow cursor movement mode. Step 202 is for the display in the slow movement mode to receive a control signal transmitted by the handheld pointer device. When the control signal is a move cursor command, as in step 203, step 204 is for the display to show a slow moving cursor accordingly. When the control signal is a select object command, as in step 205, step 206 is for the display to exit the slow cursor mode and enter selected object. When the control signal is an exit mode command, as in step 207, step 208 is for the display to exit the slow cursor movement mode.

When the operation screen shown on the display shows the location of the cursor, the user can freely browse all the information shown in the operation screen. When the user finds a target object, the user can use the handheld device to move the cursor to approach the target object. To move the cursor to approach the target object, the user can execute step 201 to enable the handheld pointer device to issue a control signal for the display to enter a slow cursor movement mode.

When the display is in the slow cursor movement mode, the cursor moves a shorter distance than the normal mode to reduce the sensitivity to the hand movement. For example, when the handheld pointer device moves 1 unit in distance, the actual movement distance may be 5 centimeters in a 30-in display under the normal mode; but in slow cursor movement mode, the distance of the cursor may be 1 centimeter in the same 30-in display. In this manner, the effect of hand trembling is reduced by five times. The ratio is only for illustrative, not for restrictive. Any other ratios can be adopted.

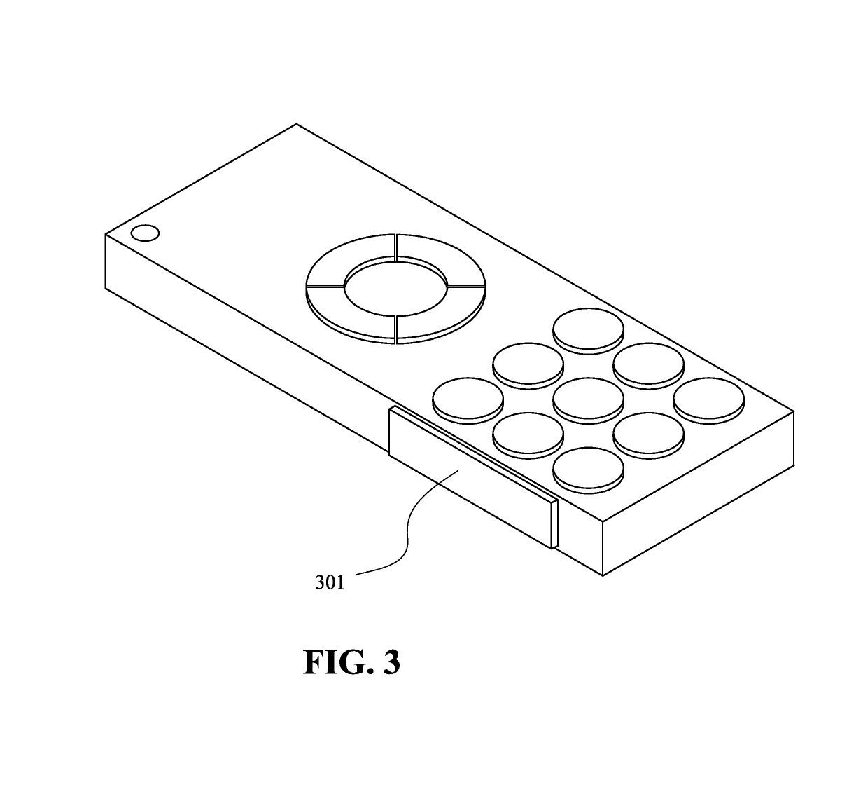

FIG. 3 shows a schematic view of a first embodiment of a handheld pointer apparatus with improved cursor operation according to the present invention. The handheld pointer with improved cursor operation is applicable to a display. As shown in FIG. 3, the handheld pointer device in this embodiment can be a light gun. The display displays a cursor to represent the corresponding location and movement of the handheld pointer device. The handheld pointer device can transmit a plurality of control signals to the display to perform a corresponding function. For example, the control signals may include an enter mode command, a move cursor command, an select object command and an exit mode command, each corresponding to entering a specific operation mode, moving a cursor displayed on the display, selecting an object display on the display, and exiting a specific operation mode respectively. In this embodiment, the specific operation mode is a slow cursor movement mode. By slowing the movement of the cursor on the display so that the cursor displayed on the display can be easily controlled and moved to select a target object displayed on the display. The handheld pointer device includes a slow-move button 301. When slow-move button 301 is pressed, a control signal is transmitted to the display so that the display enters a slow cursor movement mode. Any subsequent cursor movement operation in the slow cursor movement mode will slow mode to improve the operation. When the display is already in a slow cursor movement mode and the slow-move button is pressed again, the display will exit the slow cursor movement mode and restores normal cursor movement speed.

When the display is in the slow cursor movement mode, the cursor moves a shorter distance than the normal mode to reduce the sensitivity to the hand movement. For example, when the handheld pointer device moves 1 unit in distance, the actual movement distance may be 5 centimeters in a 30-in display under the normal mode; but in slow cursor movement mode, the distance of the cursor may be 1 centimeter in the same 30-in display. In this manner, the effect of hand trembling is reduced by five times. The ratio is only for illustrative, not for restrictive. Any other ratios can be adopted.

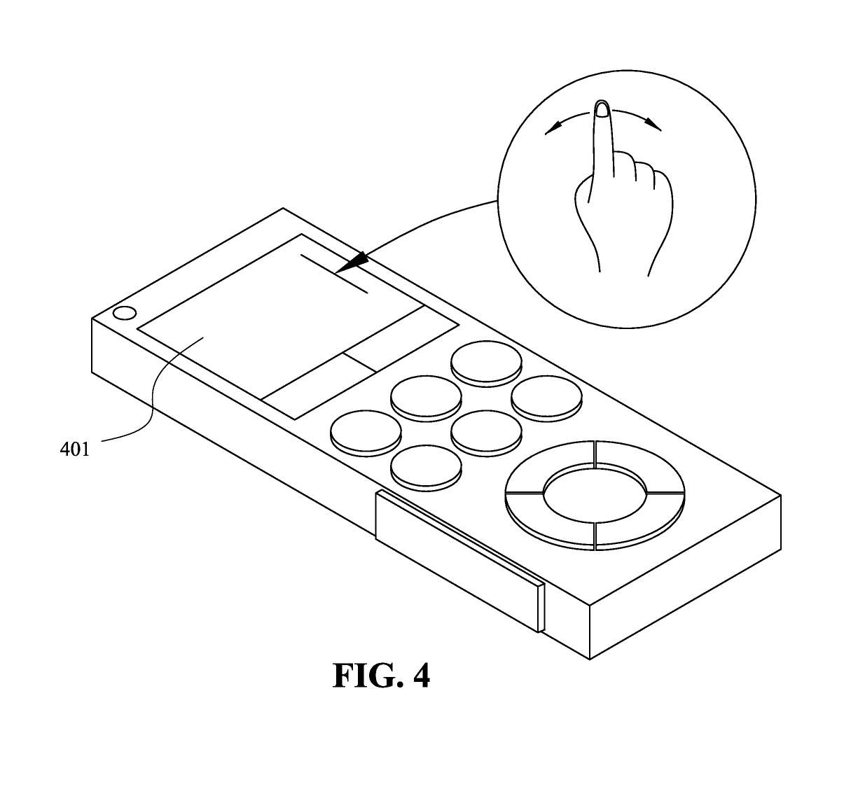

FIG. 4 shows a schematic view of a second embodiment of a handheld pointer apparatus with improved cursor operation according to the present invention. The handheld pointer with improved cursor operation is applicable to a display. As in the first embodiment in FIG. 3, the handheld pointer device includes a slow-move button. In this embodiment, the handheld pointer device is an air mouse, wherein a touch pad 401 is used to control the location and the movement of the cursor displayed on the display. The operation of this embodiment is similar to the operation of the first embodiment in FIG. 3, except that touch pad 401 is used for cursor control, instead of a light gun.

Similarly, when the display is in the slow cursor movement mode, the cursor moves a shorter distance than the normal mode to reduce the sensitivity to the hand movement. For example, when the finger on the touch pad moves 1 unit in distance, the actual movement distance may be 5 centimeters in a 30-in display under the normal mode; but in slow cursor movement mode, the distance of the cursor may be 1 centimeter in the same 30-in display. In this manner, the effect of hand trembling is reduced by five times. The ratio is only for illustrative, not for restrictive. Any other ratios can be adopted.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of improving cursor operation of a handheld pointer device in an display, applicable to a handheld pointer device and a display, said display being able to display a cursor indicating location of said handheld pointer device, said handheld pointer device able to transmit a plurality of control signals to said display to perform a corresponding function, said control signals comprising an enter mode command, a move cursor command, an select object command and an exit mode command, said method comprising the steps of:
said handheld pointer device transmitting a control signal to said display to enter a slow cursor movement mode;
said display in the slow movement mode receiving a control signal transmitted by said handheld pointer device;
when said control signal being a move cursor command, said display showing a slow moving cursor accordingly;
when said control signal being a select object command, said display to exiting the slow cursor mode and entering selected object; and
when said control signal being an exit mode command, said display exiting the slow cursor movement mode;
wherein when said display being said slow cursor movement mode, said cursor moving for a reduced distance in said display corresponding to a predefined ratio.

2. A handheld pointer device with improved cursor operation, applicable to a display, said display being able to display a cursor indicating location of said handheld pointer device, said handheld pointer device able to transmit a plurality of control signals to said display to perform a corresponding function, said control signals comprising an enter mode command, a move cursor command, an select object command and an exit mode command, said handheld pointer device comprising:
a slow-move button, when pressed said handheld pointer device transmitting a plurality of control signals to said display to enter a slow cursor movement mode;
wherein when said display being said slow cursor movement mode, said cursor moving for a reduced distance in said display corresponding to a predefined ratio.

3. The handheld pointer device as claimed in claim 2, wherein said handheld pointer device is a light gun.

4. The handheld pointer device as claimed in claim 2, wherein said handheld pointer device is an air mouse.
